(19) United States
(12) Patent Application Publication
(10) Pub. No.: US 2018/0285768 A1
(43) Pub. Date: Oct. 4, 2018

(54) METHOD AND SYSTEM FOR RENDERING A RESOLUTION FOR AN INCIDENT TICKET

(71) Applicant: WIPRO LIMITED, BANGALORE (IN)

(72) Inventor: SELVAKUBERAN KARUPPASAMY, CHENNAI (IN)

(73) Assignee: WIPRO LIMITED

(21) Appl. No.: 15/474,591

(22) Filed: Mar. 30, 2017

(51) Int. Cl. G06N 99/00; G06N 5/04; G06N 3/00

(52) U.S. Cl. CPC G06N 99/005; G06N 3/006; G06N 5/04

(57) ABSTRACT

This disclosure relates generally to incident ticket management, and more particularly to system and method for resolving incident tickets. In one embodiment, a method is provided for rendering a resolution for an incident ticket. The method includes receiving the incident ticket, analyzing the incident ticket to determine at least one error symptom, determining the resolution for the incident ticket based on the at least one error symptom using an ontology based prediction model derived from a past ticket repository, and rendering the resolution to resolve the incident ticket.

### DESCRIPTION

### Technical Field

This disclosure relates generally to incident ticket management, and more particularly to method and system for rendering resolutions for incident tickets.

### Background

Advancements in the field of Information Technology (IT) have enabled digitization of various processes and activities in an industry or an enterprise. However, to derive benefits of digitization the IT infrastructures need to run smoothly. Enterprises therefore spend significant amount of time and resources on help desk that caters to any user queries or any incident tickets with respect to the IT infrastructures from employees and/or customers. The incident ticket may include an issue or a problem that a user faces at a hardware and/or software level, or may also include a request for information on the hardware and/or software. An efficient incident ticket management is required to provide a quick resolution to such user queries or such incident tickets.

An incident ticket management system takes user queries as input (for example, incident tickets), categorizes the tickets into various classes, and routes the incident tickets to the concerned team for resolution based on the classification. Typically, there are separate teams (for example, Level 1 or Level 2 service team) to co-ordinate with end users and to resolve the incident tickets. Once the resolution is done, the incident ticket is closed. In current techniques, upon submitting the incident ticket, the incident ticket management system may pick the keywords or error symptoms from the ticket description so as to route the incident ticket to the concerned team and may also suggest similar type of past tickets (that are already resolved). This enables the resolution team to resolve the tickets at a faster rate.

However, out of all the incident tickets being raised to help desk, providing information, clarification, or self-help processes may resolve about 5% to 20% of incident tickets. Typically, Level 1 service team addresses such issues. Therefore, one of the latest trends in incident ticket management is to provide virtual agents and/or automated solutions to incident tickets wherever applicable. Such incident ticket management system accepts user query and provide the information, clarification, basic solution or automatically implement solutions based on the error symptoms of the incident tickets. Thus, in order to virtualize helpdesk and in particular Level 1 helpdesk, it is required to accurately classify the user problems into correct issue category.

However, pre-defined issue categorizations of current incident management systems are usually not fine-grained. The current techniques are therefore limited in that they may not capture the error symptoms accurately such as when the same type of error symptoms is across multiple applications. For example, “browser issue” can be across different browsers such as Internet Explorer, Mozilla, Chrome, Opera, etc. The resolutions suggested by the system may therefore be off the mark in such cases.

Past ticket repository of an enterprise may provide valuable insights in identifying the top problems and their symptoms and for deriving fine-grained categorizations. However, the volume of tickets is usually very high for manual inspection of tickets so as to derive required information. It would require a huge amount of manual effort to identify various issues under different applications, symptoms for such issues, and solutions for such issues from the past ticket repository. One of the standard techniques for automatically gathering insights from past ticket repository is by performing date clustering. However, data clustering provides indicative clusters at a very high level and lot of manual efforts may still be required to obtain fine-grained clusters. Thus, despite much advancement, the resolutions provided by virtual agents are at times not accurate.

### SUMMARY

In one embodiment, a method for rendering a resolution for an incident ticket is disclosed. In one example, the method includes receiving the incident ticket. The method further includes analyzing the incident ticket to determine at least one error symptom. The method further includes determining the resolution for the incident ticket based on the at least one error symptom using an ontology based prediction model derived from a past ticket repository. The method further includes rendering the resolution to resolve the incident ticket.

In one embodiment, a system for rendering a resolution for an incident ticket is disclosed. In one example, the system includes at least one processor and a memory communicatively coupled to the at least one processor. The memory stores processor-executable instructions, which, on execution, cause the processor to receive the incident ticket. The processor-executable instructions, on execution, further cause the processor to analyze the incident ticket to determine at least one error symptom. The processor-executable instructions, on execution, further cause the processor to determine the resolution for the incident ticket based on the at least one error symptom using an ontology based prediction mod& derived from a past ticket repository. The processor-executable instructions, on execution, further cause the processor to render the resolution to resolve the incident ticket.

In one embodiment, a non-transitory computer-readable medium storing computer-executable instructions for rendering a resolution for an incident ticket is disclosed. In one example, the stored instructions, when executed by a processor, cause the processor to perform operations including receiving the incident ticket. The operations further include analyzing the incident ticket to determine at least one error symptom. The operations further include determining the resolution for the incident ticket based on the at least one error symptom using an ontology based prediction model derived from a past ticket repository. The operations further include rendering the resolution to resolve the incident ticket.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for rendering a resolution for an incident ticket in accordance with some embodiments of the present disclosure.

FIG. 2 is a functional block diagram of an incident ticket resolution engine in accordance with some embodiments of the present disclosure,

FIG. 3 is a flow diagram of an exemplary process overview for rendering a resolution for an incident ticket in accordance with some embodiments of the present disclosure.

FIG. 4 is a flow diagram of an exemplary process for rendering a resolution for an incident ticket in accordance with some embodiments of the present disclosure.

FIG. 5 is a flow diagram of a detailed exemplary process for rendering a resolution for an incident ticket in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

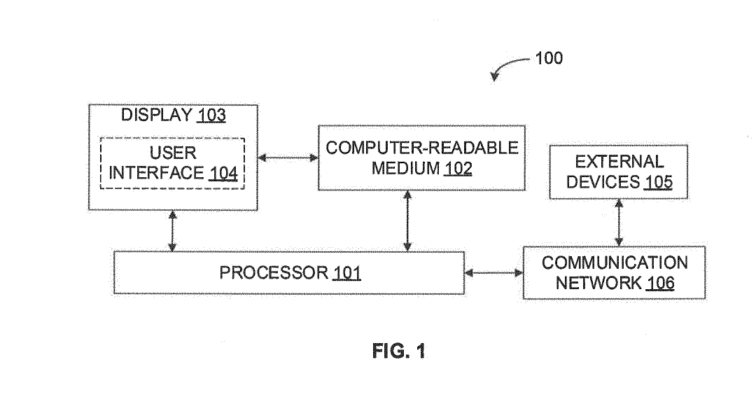

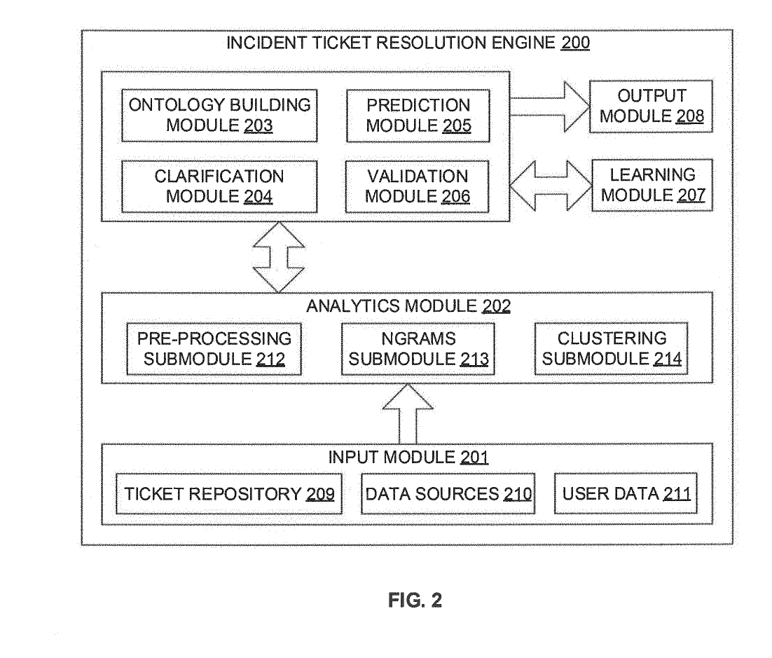

Referring now to FIG. 1, an exemplary system 100 for rendering a resolution for an incident ticket is illustrated in accordance with some embodiments of the present disclosure. In particular, the system 100 implements an incident ticket resolution engine to render resolutions for the incident tickets. As will be described in greater detail in conjunction with FIG. 2, the incident ticket resolution engine receives an incident ticket, analyzes the incident ticket to determine at least one error symptom, determines a resolution for the incident ticket based on the at least one error symptom using an ontology based prediction model derived from a past ticket repository, and renders the resolution to resolve the incident ticket,

The system 100 includes one or more processors 101, a computer-readable medium (e.g., a memory) 102, and a display 103. The computer-readable medium 102 stores instructions that, when executed by the one or more processors 101, cause the one or more processors 101 to render resolutions for incident tickets in accordance with aspects of the present disclosure. The computer-readable medium 102 may also store various data (e.g., past ticket repository, Ngrams, clusters or categories, scores, clarifications, dynamic ontology, ontology based prediction model, user queries or incident tickets, error symptoms, resolutions, etc.) that may be captured, processed, and/or required by the system 100. The system 100 interacts with a user via a user interface 104 accessible via the display 103. The system 100 may also interact with one or more external devices 105 over a communication network 106 for sending or receiving various data. The external devices 105 may include, but are not limited to, a remote server, a digital device, or another computing system.

Referring now to FIG. 2, a functional block diagram of the incident ticket resolution engine 200 implemented by the system 100 of FIG. 1 is illustrated in accordance with some embodiments of the present disclosure. The incident ticket resolution engine 200 may include various modules that perform various functions so as to determine and render resolution to incident ticket. In some embodiments, the incident ticket resolution engine 200 includes an input module 201, an analytics module 202, an ontology building module 203, a clarification module 204, a prediction module 205, a validation module 206, a learning module 207, and an output module 208.

The input module 201 receives input from one or more sources that enables the incident ticket resolution engine 200 to build an ontology based prediction model for determining an appropriate resolution for an incident ticket. The input may include ticket repository 209, input from data sources 210, and input from a user or user data 211. The ticket repository or ticket dump 209 includes data related to past incident tickets and corresponding resolutions. In some embodiments, it may be in the form of comma-separated values (.csv) file or Microsoft excel (.xls) file and may include a number of fields or parameters such as a ticket ID or ticket number, a primary application, a title, a ticket description or a problem description, a resolution category, a resolution description, and so forth. The data sources 210 may include one or more personnel from a L1 and/or a L2 service team who resolve the assigned incident tickets. They are typically within the functions of the organization but may also be from outside service provider. The input from the data sources 210 may include various other parameters such as resolution date and time, and the like. The user data 211 may be the input from the user i.e. user query in the form of incident tickets. The summary of the user's problem may be provided in the description of the ticket.

The analytics module 202 may typically include a pre-processing submodule 212, an Ngrams submodule 213, and a clustering submodule 214. The pre-processing submodule 212 extracts the structured description from the ticket repository 209 in order to generate the ontology based prediction model. In particular, the pre-processing submodule 212 processes the problem descriptions and the resolution descriptions from the ticket repository to generate corresponding structured descriptions. In some embodiments, the pre-processing may include, but is not limited to, removing URLs, removing numbers, removing generic stop words, removing custom stop words, removing Emails, removing special characters, removing date and time values, and so forth as they have little or no contribution to content, context, and meaning of the ticket. Further, in some embodiments, the pre-processing may involve extracting the specific information needed from Form based or Email based patterns using regex. Similarly, the pre-processing module 212 processes the problem description from the user query (i.e., the incident ticket) to generate the corresponding structured description.

The Ngrams submodule 213 generates the Ngrams from the structured description that effectively enable the identification of error symptoms in past incident tickets as well as hi the user query. The term Ngrams refers to continuous sequence of N words in a given structured description. In some embodiments, the Ngrams submodule 213 may determine at least one of unigrams (1 word sequence), bigrams (2 words sequence), and trigrams (3 words sequence). The clustering submodule 214 clusters incident tickets into multiple categories such that each category includes a set of tickets having at least one common characteristic or error symptom. In other words, the clustering submodule 214 forms clusters or groups of tickets that belong to same application or the tickets having similar problem query.

The ontology building module 203 dynamically builds an ontology by determining relationships between key error symptoms (i.e., multiple clusters of incident tickets) and corresponding solutions. In some embodiments, the ontology building module 203 maps the set of past incident tickets for each of the clusters with the one or more existing resolutions by analyzing the Ngrams of incident tickets in the set of past incident tickets and the Ngrams of resolutions. In some embodiments, the ontology building module 203 performs the analysis by iteratively matching the Ngrams for each of the set of past incident tickets in a given cluster with the Ngrams for each of the existing resolutions. The ontology building module 203 then scores each of the existing resolutions for a given past incident ticket from the set of past incident tickets based on a number of matches, and selects the one or more resolutions from the plurality of resolutions based on the scoring. In case of a conflict between the one or more resolutions having an identical score, the mapping module 203 may request clarification from a service user (i.e., resolution team) via the clarification module 204.

Additionally, the clarification module 204 may request an end user for any clarifications or for some other details (if required) so as to process the user tickets. For example, the clarification module 204 may request clarification from an end user (i.e., user raising the incident ticket or query) when the query is unclear or improper. The clarification module 204 may also request additional information from the end user so as to provide the appropriate solution.

The prediction module 205 builds the ontology based prediction model based on the dynamic ontology, the Ngrams, and the clusters. In other words, the prediction module 205 builds the ontology based prediction model using the ontology, which in turn is based on the mapping of Ngrams of past incident tickets in each of the clusters and Ngrams of existing solutions. The ontology based prediction model may be employed for predicting resolution for future tickets. In some embodiments, the incident ticket resolution engine 200 may analyze the user query (i.e., a new incident ticket) using the analysis module 202 so as to determine its Ngrams and a category to which the incident ticket may belong to. The incident ticket resolution engine 200 may then determine at least one error symptom for the incident ticket based on the Ngrams and the category. The incident ticket resolution engine 200 may then employ the ontology based prediction model to determine a resolution for the incident ticket based on the at least one error symptom for the incident ticket.

The validation module or the model trainer 206 in conjunction with the learning module 207 performs continuous validation and improvement of the ontology based predictive model. The learning module 207 employs a learning agent based on machine learning techniques to enable incremental learning. Thus, in some embodiments, upon receiving a user query, the prediction module 205 determines a resolution using the ontology based prediction model, while the validation module 206 validates the resolution provided by the ontology based prediction model with the help of a service level user. For a negative validation (i.e., the determined resolution not being relevant or accurate), the learning module 207 initiates a learning process based on intelligence gathered from a manual resolution of the incident ticket, and dynamically updates the ontology and the ontology based prediction model based on the learning process. The new incident ticket and the corresponding manual resolution is also updated in the ticket repository for subsequent use. It should be noted that the incident ticket resulting in the negative validation is typically a new incident ticket unrelated to a plurality of past incident tickets and/or an incident ticket not having a mapped resolution in the dynamic ontology. However, for a positive validation, the output module 208 renders the resolution to the end user so as to resolve the incident ticket.

It should be noted that the incident ticket resolution engine 200 may be implemented in programmable hardware devices such as programmable gate arrays, programmable array logic, programmable logic devices, and so forth. Alternatively, the incident ticket resolution engine 200 may be implemented in software for execution by various types of processors. An identified engine of executable code may, for instance, include one or more physical or logical blocks of computer instructions which may, for instance, be organized as an object, procedure, function, module, or other construct. Nevertheless, the executables of an identified engine need not be physically located together, but may include disparate instructions stored in different locations which, when joined logically together, include the engine and achieve the stated purpose of the engine. Indeed, an engine of executable code could be a single instruction, or many instructions, and may even be distributed over several different code segments, among different applications, and across several memory devices.

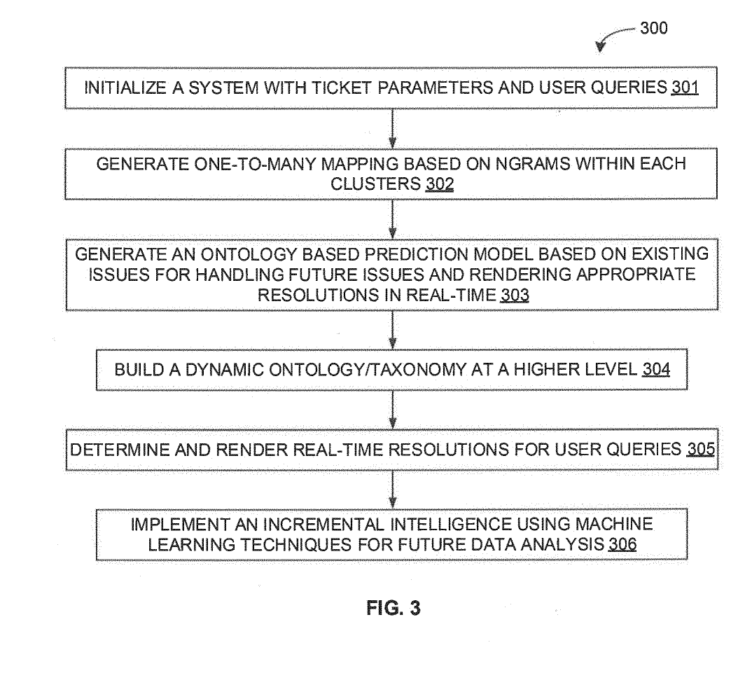

Referring now to FIG. 3, an overview of an exemplary process 300 for rendering resolution for an incident ticket is depicted via a flowchart in accordance with some embodiments of the present disclosure. The process 300 involves the steps of initializing the system with ticket parameters and user queries at step 301, generating one-to-many mapping based on Ngrams within each clusters at step 302, generating an ontology based prediction model based on existing issues for handling future issues and for rendering appropriate resolutions in real-time at step 303, building a dynamic ontology or a taxonomy at a higher level at step 304, determining and rendering real-time resolutions for user queries at step 305, and implementing an incremental intelligence using machine learning techniques for future data analysis at step 306. Each of these steps will be described in greater detail herein below.

At step 301, the system is initialized with the ticket repository or ticket dumps via the input module 201. In some embodiments, the ticket repository may include incident tickets from past two, three, or six months and corresponding resolutions. It should be noted that, in some embodiments, the tickets in the ticket dumps should not be blank (i.e., the tickets should have the problem description and the resolution description). In some embodiments, the system may be initialized with additional parameters such as resolution date, resolution time, and assigned service personnel and so forth. Further, the system may be provided with a user query mentioning issues being faced by the user in the form of an incident ticket as input.

At step 302, the past incident tickets and corresponding resolutions in the ticket dump are processed by the analytics module 202 to determine Ngrams and clusters so as to determine error symptoms The ontology building module 203 then dynamically builds the ontology by mapping relationships between error symptoms (i.e., multiple clusters of incident tickets) and corresponding solutions by matching Ngrams. Thus, relationship mapping between the incident ticket and resolutions is generated based on dusters and Ngrams. The problem description in the ticket dumps is pre-processed and Ngrams are generated. Similarly the resolution description in the ticket dumps is pre-processed and Ngrams are generated. The ontology building module 203 then maps the one or more resolutions to each incident ticket by iteratively matching the Ngrams of problem description with the Ngrams of resolution descriptions and the scoring the resolutions based on the number of matches. Thus, given an Ngrams (question), the ontology building module 203 analyzes the possible Ngrams (solutions) to match the Ngrams (question). For example, Ngrams (question) may be {browser, browser issue, internet browser issue} for an input user query “I am facing internet browser issue”. However, if multiple solutions are coming out with the same score, then the ontology building module 203 requests the clarification module 204 to request the user for clarification.

At step 303, an ontology based prediction model may be generated, by the prediction module 205, based on the existing issues for handling the future issues and rendering appropriate resolutions in real-time. The output from step 302 may be Ngrams, clusters, and dynamic ontology. The ontology based prediction mod& may therefore be built in such a way that the clusters may group the tickets based on common characteristics or error symptoms. In some embodiments, the dusters may group the tickets based on application names. It should be noted that the dusters simplify the role of relationship mapping and makes it efficient and effective. The dynamic ontology may then provide a mapping of the Ngrams of ticket description and the resolution description within each duster.

Thus, in some embodiments, given a ticket dump with problem description and the corresponding resolution description, the process of building the ontology based prediction mod& involves clustering the tickets into groups based on the application names. The process of building the ontology based prediction model further involves generating Ngrams for problem description and the corresponding resolution description. The process of building the ontology based prediction model further involves generating a mapping of Ngrams for the problem and the corresponding resolution in a given cluster. The process of building the ontology based prediction model further involves checking whether the Ngrams in problem description (any ticket) matches with Ngrams in problem description (rest of tickets) in any iteration. Similar Ngrams of the problem description are grouped and mapped with the resolution description to understand the error symptoms and the resolution mapping. The resultant ontology based prediction mod& may then be trained and validated by the validation module or the mod& trainer 206 such that the ontology based prediction model provides appropriate and accurate resolution for the user query.

At step 304, a dynamic ontology or taxonomy is built using the ontology based prediction mod& generated at step 303. As will be appreciated, the dynamic ontology is an output of the ontology based prediction model, and may be employed to determine resolutions for user queries in real-time. In some embodiments, the ontology or taxonomy may include a primary root, attributes and values, and relationships across the attributes. The attributes may be the error symptoms and have certain properties like synonyms, antonyms, hypernyms, etc. It should be noted that, for each given symptom, what will be the possible solutions is part of the ontology itself. Further, the relationships are typically arranged into a hierarchical, sibling-based relationships with its properties and values. The ontology or taxonomy may be designed around this relationship. In other words, the ontology starts with the primary root, its hierarchical, sibling relationships.

By way of an example, ontology may be built from the ticket dump as described below:
a) Assuming ticket dump has three incident tickets with following ticket descriptions in a cluster: (i) my browser is not working, (ii) Internet explorer crashed, and (iii) browser crashed, along with their corresponding resolutions;
b) By generating Ngrams, in examples (i) and (iii), ‘browser’ is found to be an entity that has some issue expounded by phrases like ‘not working’, and ‘crashed’;
c) In example (ii), Internet explorer is an entity and its parent entity may be browser;
d) Thus, all the three error symptoms belong to the same entity ‘browser’. The resolutions may be same or may not be same.
e) The mappings may therefore be as below:
Browser stop, crash, not working
   Internet Explorer
   Chrome
   Firefox
d) The ontology or taxonomy may be as below:
Issues:
   Browser
      Chrome
      Firefox
Resolution:
   Browser
e) Typically, the application name may be the cluster name and that may be the primary root.

At step 305, the pre-processing submodule in conjunction with the Ngrams submodule and the clustering submodule identifies the error symptoms that the user is facing from the user query. The pre-processing submodule has built-in natural language processing (NLP) and text analyzer components. These components analyze the user data by removing the junks, spam, and stop words, and by identifying the co-reference relationship between the sentences. The output from these components may be the keywords and named entities that may be subsequently clustered into various categories,

The NLP component receives the user query as input. The NLP component further captures the user utterances in the ticket logs and processes it. The processing of the text include identification of the individual sentences, tokenization of the sentence in the text, identification of the named entities like name of the places, organization, currency, time, date, and so forth. Also, NLP component may be employed to identify the noun and verb phrases in the sentence. Thus, the NLP component determines the relationship between the sentences in the service ticket and identifies the nouns and pronouns that describe the problem. The text analyzer component removes the unwanted junks from the user query. The text analyzer helps in the identification of keywords from the user query. The NLP component and the text analyzer component combines to form the necessary named entities and keywords that enable the identification of the clusters for the particular query or the incident ticket.

Thus, in some embodiments, by passing the user utterance to NLP and text analyzer component, the output will be the keywords from the user utterances. The output from the pre-processing submodule may then be provided to the Ngrams submodule and the clustering submodule to identify the groups the user utterance may be mapped to. In other words, the user query is processed to get the dusters and error symptoms as Ngrams.

As will be appreciated, typically the keywords may be the error symptoms. The error symptoms are then compared against the ontology or taxonomy built at step 304 using the prediction model. If the keyword matches with any of the nodes (i.e., primary roots), the prediction module 205 may check for the corresponding properties and the values. The user query may then be validated to determine if it has all the necessary information. If the user query satisfies all the validations, the resolution which is a part of the ontology may be rendered by the prediction module 205. However, if the user query does not satisfy all the validations, the clarification module 204 may trigger the clarification questions.

At step 306, an incremental intelligence may be implemented using machine learning techniques for future data analysis. The entire system may be monitored by an intelligent agent and the system learns from the user's behavior and with the existing data. From the user query entering the system till the user gets the response output, the intelligent agent captures the data and learns incrementally to aid the actual learning of the system.

As will be appreciated by one skilled in the art, a variety of processes may be employed for rendering resolution for an incident ticket. For example, the exemplary system 100 and the associated incident ticket resolution engine 200 may render resolution for an incident ticket by the processes discussed herein. In particular, as will be appreciated by those of ordinary will in the art, control logic and/or automated routines for performing the techniques and steps described herein may be implemented by the system 100 and the associated incident ticket resolution engine 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

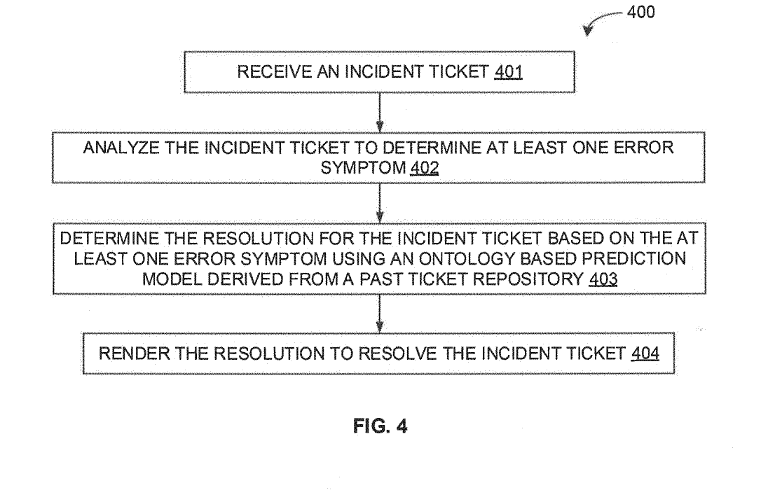

For example, referring now to FIG. 4, exemplary control logic 400 for rendering a resolution for an incident ticket via a system, such as system 100, is depicted via a flowchart in accordance with some embodiments of the present disclosure. As illustrated in the flowchart, the control logic 400 includes the steps of receiving the incident ticket at step 401, analyzing the incident ticket to determine at least one error symptom at step 402, determining the resolution for the incident ticket based on the at least one error symptom using an ontology based prediction model derived from a past ticket repository at step 403, and rendering the resolution to resolve the incident ticket at step 404.

In some embodiments, analyzing the incident ticket at step 402 includes pre-processing the incident ticket. Further, in some embodiments, analyzing the incident ticket at step 402 includes determining a plurality of N-grams and a category for the incident ticket, and determining the at least one error symptom based on the plurality of N-grams and the category.

In some embodiments, the control logic 400 may further include the steps of validating the resolution from a user, and for a negative validation, initiating a learning process based on intelligence gathered from a manual resolution of the incident ticket. It should be noted that the incident ticket resulting in the negative validation is a new incident ticket unrelated to a plurality of past incident tickets or an incident ticket not having a mapped resolution in the dynamic ontology. The control logic 400 may further include the step of dynamically updating the ontology or updating a ticket repository based on the learning process.

In some embodiments, the control logic 400 may further include the steps of receiving the past ticket repository including a plurality of past incident tickets and a plurality of resolutions, determining a plurality of N-grams for each of the plurality of past incident tickets and a plurality of N-grams for each of the plurality of resolutions, and clustering the plurality of past incident tickets into a plurality of categories. It should be noted that each category includes a set of past incident tickets from the plurality of past incident tickets having at least one common error symptom or characteristic. The control logic 400 may further include the steps of mapping, for each cluster, the set of past incident tickets with one or more resolutions from the plurality of resolutions by analyzing a plurality of N-grams for each of the set of past incident tickets and the plurality of N-grams for each of the plurality of resolutions. The control logic 400 may further include the steps of deriving the ontology based prediction model based on the clustering and the mappings, and building a dynamic ontology based on the ontology based prediction model.

In some embodiments, the control logic 400 may further include the step of pre-processing the plurality of past incident tickets and the plurality of past resolutions. Additionally, in some embodiments, the control logic 400 may further include the step of training and validating the ontology based prediction model. Further, in some embodiments analyzing the plurality of N-grams for each of the set of past incident tickets and the plurality of N-grams for each of the plurality of resolutions includes iteratively matching each of the plurality of N-grams for each of the set of past incident tickets with each of the plurality of N-grams for each of the plurality of resolutions, and for a given past incident ticket from the set of past incident tickets, scoring each of the plurality of resolutions based on a number of matches, and selecting one or more resolutions from the plurality of resolutions based on the scoring. Moreover, in some embodiments, the control logic 400 may further include the step of requesting clarification from a user in case of a conflict between the one or more resolutions having an identical score,

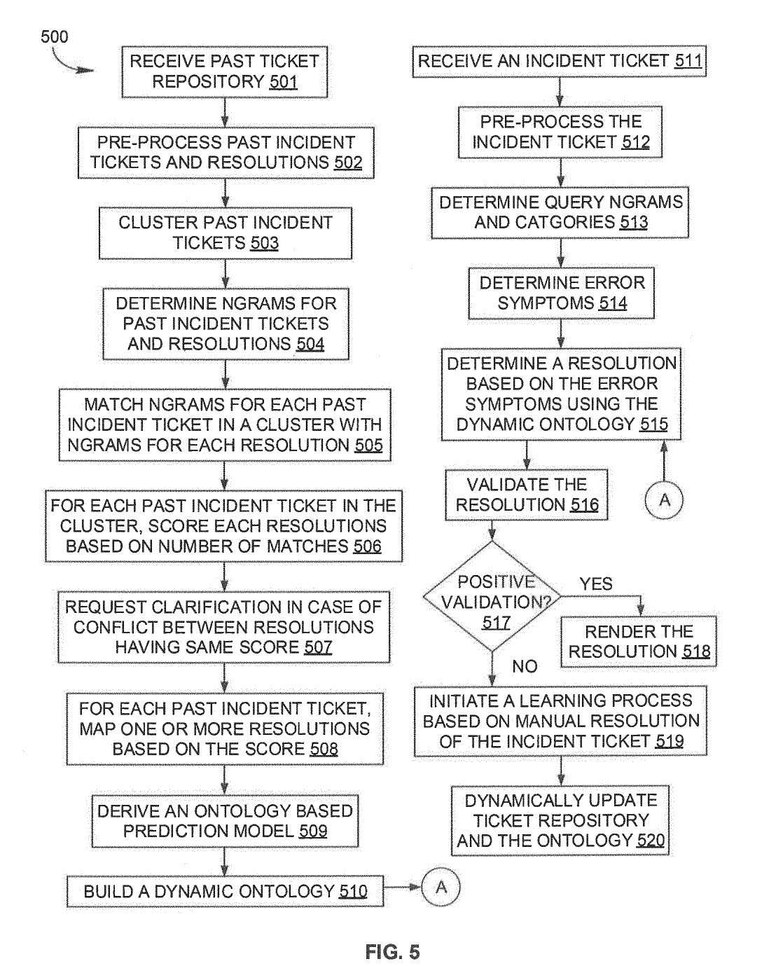

Referring now to FIG. 5, exemplary control logic 500 for rendering resolution for an incident ticket is depicted in greater detail via a flowchart in accordance with some embodiments of the present disclosure. As illustrated in the flowchart, the control logic 500 includes the steps of receiving past ticket repository including of past incident tickets and corresponding resolutions at step 501, pre-processing the past incident tickets and the resolutions at step 502, and clustering the past incident tickets into multiple categories at step 503. The control logic 500 further includes the steps of determining Ngrams for past incident tickets and resolutions at step 504, matching Ngrams for each past incident ticket in a cluster with Ngrams for each resolution at step 505, and for each past incident ticket in the cluster, scoring each resolutions based on number of matches at step 506. The control logic 500 further includes the step of requesting clarification from a user on case of a conflict between resolutions having same score at step 507. The control logic 500 further includes the step of mapping each past incident ticket with one or more resolutions based on the score at step 508. As will be appreciated, the steps 505 through 508 may be repeated for each of the clusters. The control logic 500 further includes the step of deriving an ontology based prediction model based on the clustering and the mappings at step 509, and building a dynamic ontology from the ontology based prediction model at step 510.

Additionally, the control logic 500 includes the steps of receiving an incident ticket from a user at step 511, pre-processing the incident ticket at step 512, analyzing the incident ticket to determine query Ngrams as well as one or more categories to which the incident ticket may belong to at step 513, and determining one or more error symptoms based on the query Ngrams and the one or more categories at step 514. The control logic 500 further includes the step of determining a resolution based on the one or more error symptoms using the dynamic ontology at step 515. It should be noted that, in some embodiments, the determination at step 515 involves referring to the dynamic ontology derived from the ticket repository at steps 510. Alternatively, it should be noted that, in some embodiments, the dynamic ontology derived from a repository of past incident tickets and resolutions may be separately received from an external source and therefore need not be derived by the control logic 500.

Moreover, the control logic 500 includes the steps of validating the resolution at step 515, and determining if the validation is a positive validation or not at step 517, if the resolution provided is appropriate and accurate then it is a positive validation, and the control logic 500 concludes by recording as such and rendering the resolution for resolving the ticket at step 518. However, if the resolution provided is not appropriate and/or not accurate then it is a negative validation. In such cases, the incident ticket is taken for manual resolution. Further, in such cases, the control logic 500 includes the step of initiating a learning process based on the manual resolution of the incident ticket at step 519. Additionally, in such cases, the control logic 500 includes the step of updating the ticket repository with the incident ticket and its resolution, as well as dynamically updating the ontology based prediction model and consequently the ontology at step 520.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

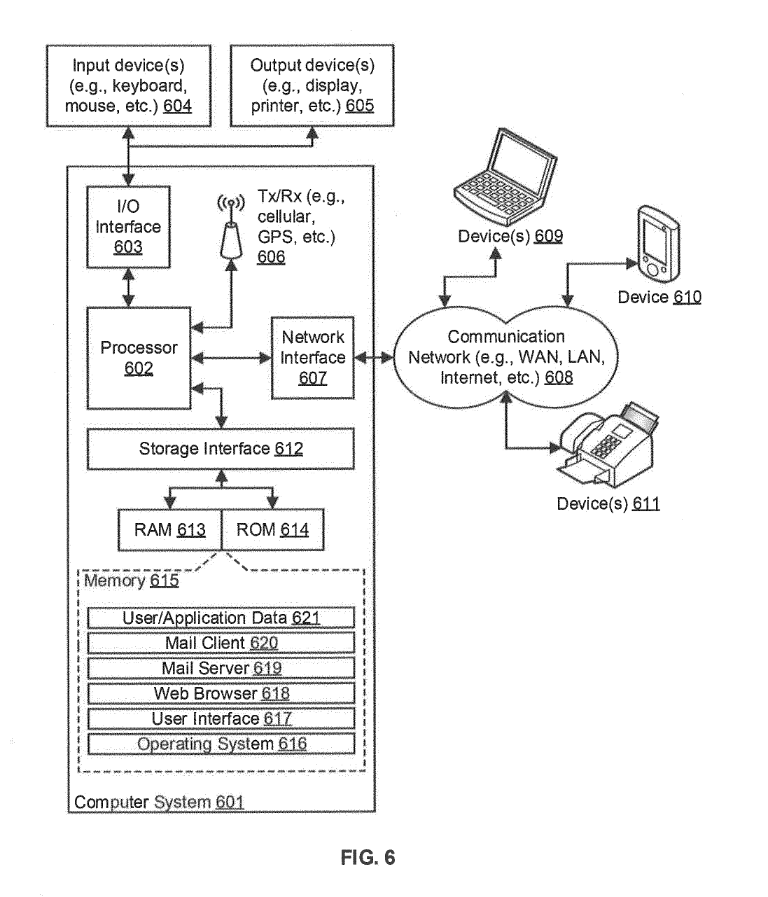

The disclosed methods and systems may be implemented on a conventional or a general-purpose computer system, such as a personal computer (PC) or server computer. Referring now to FIG. 6, a block diagram of an exemplary computer system 601 for implementing embodiments consistent with the present disclosure is illustrated. Variations of computer system 601 may be used for implementing system 100 and incident ticket resolution engine 200 for rendering resolution for an incident ticket. Computer system 601 may include a central processing unit (“CPU” or “processor”) 602. Processor 602 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., Texas instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.), collectively referred to as memory 615, via a storage interface 612. The storage interface 612 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 615 may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Rash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. (e.g., past ticket repository, Ngrams, clusters or categories, scores, clarifications, dynamic ontology, ontology based prediction model, user queries or incident tickets, error symptoms, resolutions, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e,g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide for automatic creation and building of ontology or taxonomy from a ticket dump (i.e., past tickets repository), thereby facilitating virtualization of incident management helpdesk. The past ticket repository usually contain problem and resolution description that may provide valuable insights with respect to top issues, their symptoms, types of issues and so forth. The techniques described in the various embodiments discussed above provide for a mechanism to mine the past tickets repository so as to identify problems, symptoms, and provide inputs for creation of issue ontology in automatic manner.

Further, as will be appreciated by those skilled hi the art, the techniques described in the various embodiments discussed above result in automated, efficient, and speedy (hi many a case, instant) resolution of incident tickets, or availability of information or clarifications with respect to the incident tickets. The ontology based prediction model and the resultant ontology derived from past tickets repository may determine the most appropriate or accurate resolution for an incident ticket in real-time. Further, the techniques described in the various embodiments discussed above increase the productivity of the user as well as the resolution team handling those tickets by saving their effort as well as time. The user may have quick resolution to his query while the resolution team may focus on new issues that are not in ticket dump and for which there are no mapped resolutions.

Additionally, as will be appreciated by those skilled in the art, the ontology based prediction model learns new errors and tries to map the resolutions for the new errors. The prediction mod& understands the relationship between the error and the cluster/group in which the error would belong to by continuous learning. Further, the prediction mod& may analyze a number of times same error is being faced by the users in a given period of time and other such information. Such information may be very useful in not only improving the prediction mod& but also the overall IT infrastructure,

The specification has described system and method for rendering resolution for an incident ticket. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for rendering a resolution for an incident ticket, the method comprising:
receiving, by an incident ticket resolution system, the incident ticket;
analyzing, by the incident ticket resolution system, the incident ticket to determine at least one error symptom;
determining, by the incident ticket resolution system, the resolution for the incident ticket based on the at least one error symptom using an ontology based prediction model derived from a past ticket repository; and
rendering, by the incident ticket resolution system, the resolution to resolve the incident ticket.

2. The method of claim 1, wherein analyzing the incident ticket comprises pre-processing the incident ticket.

3. The method of claim 1, wherein analyzing the incident ticket comprises:
determining a plurality of N-grams and a category for the incident ticket; and
determining the at least one error symptom based on the plurality of N-grams and the category.

4. The method of claim 1, further comprising:
validating the resolution from a user;
for a negative validation, initiating a learning process based on intelligence gathered from a manual resolution of the incident ticket, wherein the incident ticket resulting in the negative validation is a new incident ticket unrelated to a plurality of past incident tickets or not having a mapped resolution in an ontology; and
dynamically updating the ontology based on the learning process.

5. The method of claim 1, further comprising:
receiving the past ticket repository comprising a plurality of past incident tickets and a plurality of resolutions;
determining a plurality of N-grams for each of the plurality of past incident tickets and a plurality of N-grams for each of the plurality of resolutions;
clustering the plurality of past incident tickets into a plurality of categories, wherein each category comprises a set of past incident tickets having at least one common error symptom;
for each cluster, mapping the set of past incident tickets with one or more resolutions from the plurality of resolutions by analyzing a plurality of N-grams for each of the set of past incident tickets and the plurality of N-grams for each of the plurality of resolutions;
deriving the ontology based prediction model based on the clustering and the mappings; and
building a dynamic ontology based on the ontology based prediction model.

6. The method of claim 5, further comprising pre-processing the plurality of past incident tickets and the plurality of resolutions.

7. The method of claim 5, further comprising training and validating the ontology based prediction model.

8. The method of claim 5, wherein analyzing the plurality of N-grams for each of the set of past incident tickets and the plurality of N-grams for each of the plurality of resolutions comprises:
iteratively matching each of the plurality of N-grams for each of the set of past incident tickets with each of the plurality of N-grams for each of the plurality of resolutions;
for a given past incident ticket from the set of past incident tickets,
scoring each of the plurality of resolutions based on a number of matches; and
selecting one or more resolutions from the plurality of resolutions based on the scoring.

9. The method of claim 8, further comprising requesting clarification from a user in case of a conflict between the one or more resolutions having an identical score.

10. An incident ticket resolution system for providing a resolution for an incident ticket, the system comprising:
at least one processor; and
a computer-readable medium storing instructions that, when executed by the at least one processor, cause the at least one processor to perform operations comprising:
receiving the incident ticket;
analyzing the incident ticket to determine at least one error symptom;
determining the resolution for the incident ticket based on the at least one error symptom using an ontology based prediction model derived from a past ticket repository; and
rendering the resolution to resolve the incident ticket.

11. The incident ticket resolution system of claim 10, wherein analyzing the incident ticket comprises:
determining a plurality of N-grams and a category for the incident ticket; and
determining the at least one error symptom based on the plurality of N-grams and the category.

12. The incident ticket resolution system of claim 10, wherein the operations further comprise:
validating the resolution from a user;
for a negative validation, initiating a learning process based on intelligence gathered from a manual resolution of the incident ticket, wherein the incident ticket resulting in the negative validation is a new incident ticket unrelated to a plurality of past incident tickets or not having a mapped resolution in an ontology; and
dynamically updating the ontology based on the learning process,

13. The incident ticket resolution system of claim 10, wherein the operations further comprise:
receiving the past ticket repository comprising a plurality of past incident tickets and a plurality of resolutions;
determining a plurality of N-grams for each of the plurality of past incident tickets and a plurality of N-grams for each of the plurality of resolutions;
clustering the plurality of past incident tickets into a plurality of categories, wherein each category comprises a set of past incident tickets having at least one common error symptom;
for each cluster, mapping the set of past incident tickets with one or more resolutions from the plurality of resolutions by analyzing a plurality of N-grams for each of the set of past incident tickets and the plurality of N-grams for each of the plurality of resolutions;
deriving the ontology based prediction model based on the clustering and the mappings; and
building a dynamic ontology based on the ontology based prediction model.

14. The incident ticket resolution system of claim 13, wherein analyzing the plurality of N-grams for each of the set of past incident tickets and the plurality of N-grams for each of the plurality of resolutions comprises:
iteratively matching each of the plurality of N-grams for each of the set of past incident tickets with each of the plurality of N-grams for each of the plurality of resolutions;
for a given past incident ticket from the set of past incident tickets,
scoring each of the plurality of resolutions based on a number of matches; and
selecting one or more resolutions from the plurality of resolutions based on the scoring.

15. The incident ticket resolution system of claim 14, wherein the operations further comprise requesting clarification from a user in case of a conflict between the one or more resolutions having an identical score.

16. A non-transitory computer-readable medium storing computer-executable instructions for:
receiving the incident ticket;
analyzing the incident ticket to determine at least one error symptom;
determining the resolution for the incident ticket based on the at least one error symptom using an ontology based prediction model derived from a past ticket repository; and
rendering the resolution to resolve the incident ticket.

17. The non-transitory computer-readable medium of claim 16, wherein analyzing the incident ticket comprises:
determining a plurality of N-grams and a category for the incident ticket; and
determining the at least one error symptom based on the plurality of N-grams and the category.

18. The non-transitory computer-readable medium of claim 16, further storing computer-executable instructions for:
validating the resolution from a user;
for a negative validation, initiating a learning process based on intelligence gathered from a manual resolution of the incident ticket, wherein the incident ticket resulting in the negative validation is a new incident ticket unrelated to a plurality of past incident tickets or not having a mapped resolution in an ontology; and
dynamically updating the ontology based on the learning process.

19. The non-transitory computer-readable medium of claim 16, further storing computer-executable instructions for:
receiving the past ticket repository comprising a plurality of past incident tickets and a plurality of resolutions;
determining a plurality of N-grams for each of the plurality of past incident tickets and a plurality of N-grams for each of the plurality of resolutions;
clustering the plurality of past incident tickets into a plurality of categories, wherein each category comprises a set of past incident tickets having at least one common error symptom;
for each cluster, mapping the set of past incident tickets with one or more resolutions from the plurality of resolutions by analyzing a plurality of N-grams for each of the set of past incident tickets and the plurality of N-grams for each of the plurality of resolutions;
deriving the ontology based prediction model based on the clustering and the mappings; and
building a dynamic ontology based on the ontology based prediction model.

20. The non-transitory computer-readable medium of claim 19, wherein analyzing the plurality of N-grams for each of the set of past incident tickets and the plurality of N-grams for each of the plurality of resolutions comprises:
iteratively matching each of the plurality of N-grams for each of the set of past incident tickets with each of the plurality of N-grams for each of the plurality of resolutions;
for a given past incident ticket from the set of past incident tickets,
scoring each of the plurality of resolutions based on a number of matches; and
selecting one or more resolutions from the plurality of resolutions based on the scoring.
